(19) United States
(12) Patent Application Publication
(10) Pub. No.: US 2003/0031174 A1
(43) Pub. Date: Feb. 13, 2003

(54) Methods and systems for intact datagram routing

(76) Inventor: Herzel Laor, Boulder, CO (US)

Correspondence Address: KILPATRICK STOCKTON LLP, 607 14TH STREET, N.W., SUITE 900, WASHINGTON, DC, 20005, US

(21) Appl. No.: 10/214,735

(22) Filed: Aug. 9, 2002

Related U.S. Application Data
(60) Provisional application No. 60/311,042, filed on Aug. 9, 2001.

(51) Int. Cl. H04L 12/28

(52) U.S. Cl. 370/389; 370/536

(57) ABSTRACT

A router for routing a datagram comprising at least one input operative to accept a single stream of data; a plurality of outputs, each output operative to transmit a single stream of data; and a processor. The processor operative to read destination information from a datagram provided via a communicated input, determine which communicated output will advance the read datagram toward the destination indicted in the datagram, and direct the read datagram to a communicated output determined to advance the read datagram toward the read datagram's destination. The router operates without deconstructing the data portion of the datagram.

### CROSS REFERENCE TO RELATED APPLICATION

This application claims priority to Provisional Application No. 60/311,042, filed Aug. 9, 2001, the entire disclosure of which is hereby incorporated herein by reference.

### FIELD OF THE INVENTION

The present invention relates generally to data communications. More specifically, the present invention relates to data routers and networks of data routers that operate primarily on entire datagrams.

### BACKGROUND

The infrastructure for national data communications includes transmission media (e.g., fiber optic cables, radio frequency links, copper wires), routers, multiplexors, and associated hardware and software. This infrastructure is arranged into various nationwide backbone networks, hubs, and local networks. The growth of data traffic on the many backbone networks, due in significant part to Internet transmissions, is currently doubling at a rate of once every 12-16 months. The capacity of transmission media in general and fiber optic media in particular is growing fast. Techniques such as Dense Wavelength Division Multiplexing (WDM) allow hundreds of wavelengths to be transmitted over each fiber in a fiber optic cable. The growth in router capacity, however, lags behind the progress in transmission media, doubling only every three to four years. Although terabit per second routers are expected to be available soon, those routers likely will be expensive, large and consume a significant amount of energy.

In a typical national backbone network, transmission paths or lines are optical fibers and fiber optic cables. Messages are transmitted along the transmission lines by a laser at a selected wavelength. In general, each fiber optic cable can include tens of optical fibers, and each optical fiber is capable of transporting hundreds of wavelengths or frequencies of light. A single wavelength is currently able to carry 2.5 Giga bits per second (Gbps) of data. Transmission rates of 10 Gbps should be available soon, and 40 Gbps transmission rates are anticipated within 2-3 years.

The optical fiber and fiber optic cable transmissions lines converge from various directions at switching centers located throughout the national backbone network. These switching centers include routers having numerous ports or inputs and outputs to direct and distribute the data being transmitted. These routers connect to all of the wavelengths or frequencies being transmitted through the transmission lines. The routers in each switching center are used to connect to the national backbone network to local networks and to other national backbone networks.

In order to transmit and route data across the national backbone network, the data or messages, referred to as datagrams, are deconstructed and chopped into smaller components called packets. In order to transport these packets, each packet must be assigned a specific time slot in a specific wavelength or frequency along a specific transmission line or optical fiber. This requisite specificity makes synchronization critical in data transmission, both within the transmission line and among the ports of a switch or router.

Each packet on each wavelength or frequency contains multiplexed data. For example, a packet containing Internet Protocol (IP) data includes two parts. The first part contains destination information related to the packet, and the second part contains the actual data or message.

The routers in the switching centers need to receive each packet, store the packet for a period of time, decipher the destination information related to the packet during this time, select an available out-going transmission slot in a suitable wavelength going to the required destination, retrieve the packet from memory and transmit the packet. In a terabit router, for example, all of these steps must be performed concurrently for millions of packets. These requirements create the need for large, complex routers having significant amounts of memory and processing power. This requisite complexity and size for the routers makes the current routers used in current networks a likely source of congestion.

It should also be noted that for communications where the required Quality of Service (QoS) calls for real-time, in-order communications (e.g., voice), circuit switching has been used. However, for communications with different QoS requirements, the rigidity of circuit switching is unnecessarily restrictive.

Since, the existing transmission capacity is large and sufficient to handle current and predicted data transmission requirements, but the current system of routing the data is insufficient and creates bottlenecks in networks, data routers and switching centers are needed that alleviate the bottlenecks associated with current network routers and take advantage of the disparity between transmission capacity and routing efficiency; while at the same time avoiding the rigidity of circuit switching.

### SUMMARY OF THE INVENTION

The present invention encompasses an intact datagram router (IDR), as opposed to a conventional packet router, methods for its use, along with network construction and operation using such routers and networks. The IDR includes at least one input suitable for attachment to an incoming data transmission line or cable, a plurality of outputs suitable for attachment to a plurality of outgoing data transmission lines or cables, and a processor coupled to the input and outputs. The processor is capable of receiving an input stream of data containing directional routing information and directs the data stream to one or more appropriate outputs in accordance with the directional routing information. In order to increase the efficiency and speed of the data transmission, the IDR can also include a memory buffer coupled to the processor to temporarily store the data stream.

Each output of an IDR corresponds to a direction in relation to the IDR, additional IRDs, local area networks, and national backbone networks. In order to determine which output to direct the stream of data to, the processor checks the inputs and outputs, identifies connections to the inputs and outputs, determines the network structure in which the IDR is positioned, and directs the data stream to a first available output in the general direction of the routing information in accordance with this network structure. In preferred embodiments, determining network structure involves the IDR obtaining information about each of its destinations and determining which part of the network its destination serves. On a national net, the answer will be names of local networks, with list of users on each network, and names of other national nets. In a local net, the answers will be the lists of served connections. A plurality of these IDRs can be interconnected and coupled together to form a switching center for use in a data transmission network.

In addition to the IDRs, each switching center can include one or more multiplexors (WDM or time-domain - depending on whether multiplexing is done in optic or electrical domain) and concentrators coupled to the outputs of the routers to combine several slower data output streams into a single high speed stream of data. The switching center can also include one or more demultiplexors and deconcentrators coupled to the incoming data streams to break down an aggregate stream of data (e.g., by wavelength as in WDM, by time as in time-domain multiplexing, by frequency) into a plurality of tributary streams. The tributary streams of data are then directed to IDRs in the switching center. In addition to sharing information about the structure and availability of the network, the IDRs exchange information about the interconnection structure and availability of other IDRs in the switching center. Concentrators and deconcentrators are characterized by the ability to combine or decombine, respectively, data streams. Other than time domain and WDM techniques, the present invention contemplates other methods known to those skilled in the art for these functions as encompassed by “concentrator” and “deconcentrater” and described herein.

In order to use the routers, a single composite stream of data containing a plurality of tributary streams can be deconcentrated into tributary streams, e.g., having a single transmission frequency and at a transmission speed that the router can accept. The stream of data carries datagrams, each datagram is an intact (whole) datagram (not chopped into packets) that carry destination information and data. The destination information is read and the entire datagram is directed in accordance with this destination information. Each individual datagram is routed/directed to any one of the available transmission lines headed in the general direction of the destination information. In one embodiment, in order to increase the availability of transmission lines, all of the transmission lines are loaded to less than full capacity.

### BRIEF DESCRIPTION OF THE DRAWINGS

FIG. 1 is an illustration of a national backbone network.

FIG. 2 is a schematic representation of the limited directivity data router of the present invention.

FIG. 3 is a schematic representation of a switching center using those routers.

FIG. 4 is a schematic representation of a local network, a national backbone network, and an interface router configuration.

### DETAILED DESCRIPTION OF A PREFERRED EMBODIMENT

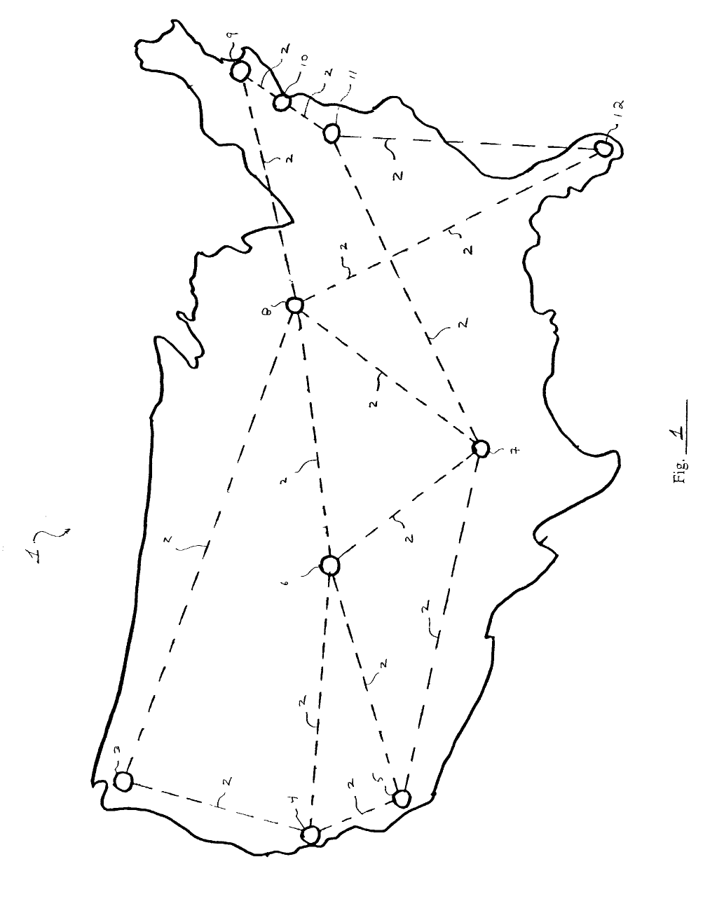

Referring initially to FIG. 1, an example of a national backbone network 1 is illustrated. The national backbone network includes a plurality of transmission lines 2. Suitable materials for the transmission lines 2 include optical fibers and fiber optic cables. The transmission lines 2 connect a plurality of hubs located in the national backbone network at, for example, Seattle, Wash. 3, Los Angeles, Calif. 4, San Diego, Calif. 5, Denver, Colo. 6, Dallas, Tex. 7, Chicago, Ill. 8, Boston, Mass. 9, New York, N.Y. 10, Washington, D.C. 11, and Miami, Fla. 12. These centers or hubs can contain a plurality of switching centers, local networks and cross connections to other national backbone networks. Many such national networks exist and are well known to one of ordinary skill in the art. The various hubs have transmission lines 2 converging and emerging to interconnect all of the hubs in the network 1. Each transmission line 2 attached to a hub provides a connection to a particular hub or in a general geographical direction. Because of the locations of the hubs, the number of transmission lines 2 at each hub varies from five in the case of Chicago 8 to four at Denver 6 and Dallas 7 and two for Seattle 3, Boston 9, and New York 10, and Miami 12.

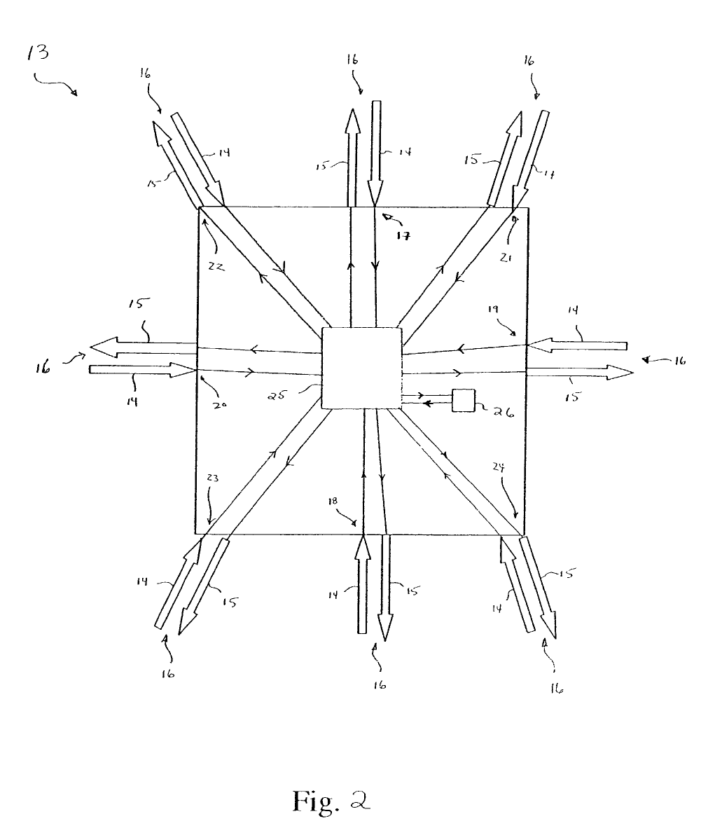

Each of the hubs includes a plurality of IDRs 13. In FIG. 2, one IDR is shown. The IDR 13 is constructed to direct datagrams toward the destination indicated in the datagram. Each IDR includes a limited number of inputs and outputs, and a capacity to store or hold streams of data. A router with a limited number of inputs and outputs is better served by ready access to transmission lines for routed outgoing streams of data. Since the current and future transmission capacity for network data transmissions exhibits more performance margin than either current or anticipated switching technology and historical need, routers likely will have ready access to transmission capacity.

In one embodiment, the IDR 13 includes at least one input 14 for attachment to an incoming transmission line or cable 2 and at least one output 15 for attachment to an outgoing data transmission line 2. Preferably, the IDR 13 includes a plurality of inputs 14 and plurality of outputs 15. In order to provide for routing feedback and reverse transmissions, the inputs 14 and outputs 15 are preferably grouped as input/output pairs 16. Input/output pairs 16 are provided that correspond to the general geographic location in relation to the IDR 13 or hub, for example the direction from Dallas 7 to Chicago 8 or the direction from Los Angeles 4 to Denver 6. Suitable geographic directions include North 17, South 18, East 19, and West 20. The general geographic directions are in some cases not in the four orthogonal directions, but as in the case of Miami there are two transmission lines 2 going North and North-West. In some embodiments, in addition to ports corresponding to directions away from a switching center, input/output ports 21, 22 are provided for a first interconnection 21 to one or more additional IDRs, a second interconnection 22 to one or more additional IDRs, one or more connections to local networks 23, and one or more connections to other national backbone networks 24.

When an IDR 13 is first installed and being connected to the network, it will query the other IDRs that it is connected to by transmission input/output pairs 16. Each other IDR 13 will inform the IDR 13 which destinations it services. This connecting information is saved in a table at the IDR memory and is updated over time. The IDR 13 will not “know” that port 17 is going “North”, but that by directing a datagram to this port, the datagram will reach its destination, preferably with less hops. When a datagram is arriving, the IDR 13 reads the datagram's destination header and determines an output 15 for this specific datagram.

In one embodiment, the IDR 13 has 8 ports and eight associated input/output pairs 16. In another embodiment, the IDR 13 may have less than eight ports as would be required, for example, at Seattle 3 that only requires East 19 and South 18 directions. In yet another embodiment, the IDR 13 has from about 20 to about 30 ports. It is not necessary, however, that each IDR 13 be connected to and capable of transmitting directly to all transmission lines going to a specific destination., An IDR 13 can only one data stream available in a transmission line 2; or a few—for example, in Miami 12 it may have two ports connected to the transmission line 2 going to Washington D.C. 11 and two to Chicago 8. The transmission line 2 may be constructed of ten fibers going in each direction and a hundred wavelengths in each fiber, for a total of one thousand wavelengths in each direction. A specific IDR 13 can have access to only one (or few) of these wavelengths for transmission and to only one (or few) of the wavelengths for reception. However, if the IDR 13 needs to send data in the direction that the specific transmission line 2 is going, it is immaterial on which wavelength the datagram will go.

Each IDR 13 also includes a logical processor 25 coupled to the input/output pairs 16 (via various ports, e.g., 17, 18, 21, 22, and capable of receiving, reading (at least a directional portion of the datagram address), and analyzing a datagrams from any one of the inputs 14 and of redirecting that datagram to any one or more of the outputs 15. Preferably, the processor 25 is sufficient to simultaneously receive, read, analyze, and transmit datagrams to all of the inputs 14 and outputs 15 connected to the IDR 13. Each datagram will be sent as an intact stream of bits, and will not be cut into packets as in the existing networks. A typical transmission line 2 in a national backbone network 1 carries a large amount of data on many different wavelengths. For example, the transmission line connected to the IDR 13 may include 500 different wavelengths. In the present invention, 500 different IDRs 13 will be attached to this data transmission line to handle the 500 wavelengths, each IDR 13 handling datagrams in the stream of incoming data on only one wavelength or frequency. Apart from optical wavelength division multiplexing/demultiplexing, there may be a need for time domain multiplexing/demultiplexing to align the transmission capability of the transmission lined to the routers—embodiments of the present invention provide such multiplexing/demultiplexing as needed. In practice, transmission lines and routers may be installed years apart, with say 2.5 Gbps capacity at the routers and 10 Gbps at the transmission lines, or vice versa.

Each of the inputs 14 in each IDR 13 of the present invention can be tuned to receive input at the single target frequency. Each of the outputs 15 can be transmitting only one wavelength as well. In one embodiment, each IDR 13 reads or detects only the wavelength or frequency to which it is tuned out of the hundreds of wavelengths or frequencies that are being transported through the transmission line 2. In such a case, the optical WDM equipment is avoided. In another embodiment, WDM equipment is used to optically demultiplex the many wavelengths riding on a fiber, and each wavelength is fed to only one IDR. Each wavelength or frequency is preferably carried to the IDR 13 on a single “tributary” fiber in a fiber optic cable transmission line.

Each IDR 13 can also include at least one memory buffer 26. The memory buffer 26 is coupled to the processor and provides temporary storage of datagrams. This temporary storage allows a small degree of data storage to permit increased utilization of the transmission capacity for a required level of service. The memory buffer 26 of the present invention need not be as large as the memory storage capacity provided in routers in traditional data networks that perform the chopping datagrams into packets and combining packets into datagrams.

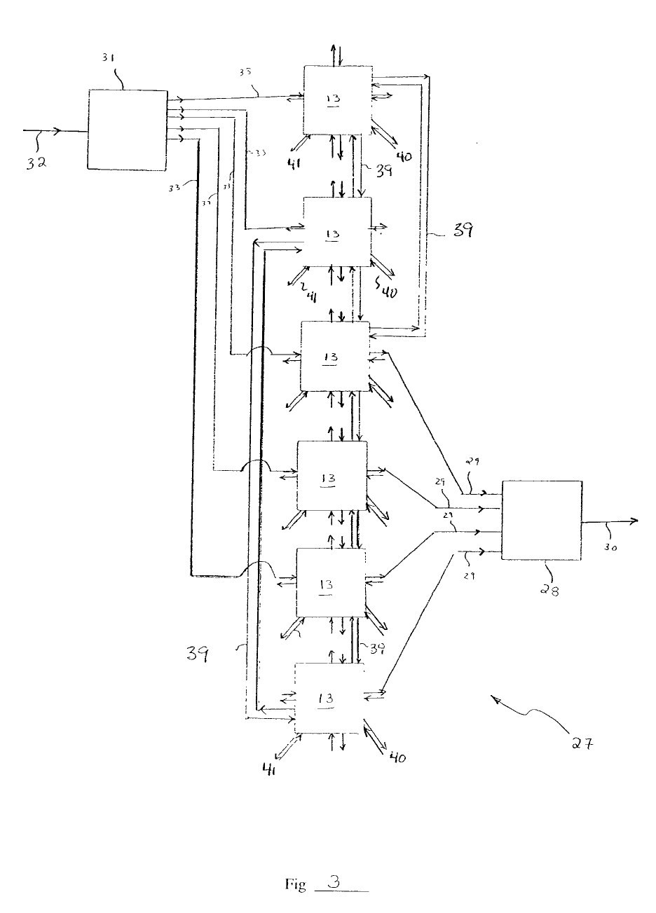

As is shown in FIG. 3, a plurality of the IDRs 13 can be combined and interconnected to create a switching center 27. Although six routers 13 are shown, the switching center 27 can include any number of routers including enough routers to provide one router for each wavelength or frequency on either an input or output transmission line 2. Small switching centers can be located throughout a national backbone network. For example, the transmission line connecting Denver 6 and Chicago 8 may include 20 small switching centers (like beads on a string) servicing the towns in-between. Large switching centers are preferably located at hubs in the network at locations where two or more network transmission lines 2 intersect. Switching centers can also be located at or in local networks as well. In addition, multiple switching centers can be maintained at a single location in a network. If there is more than one IDR 13 in a switching center, each IDR 13 in the switching center is coupled to at least to one other IDR 13 by the router interconnection 39. Interconnects 39 are used by the IDR 13 to learn the identity of the other IDRs 13 in the switching center, and to send datagram between IDRs 13. More than one interconnect 39 can be installed for each IDR 13. These interconnects 39 provide for, inter alia, communication and data transfer among the IDRs 13 in a switching center. Additional IDR interconnections 39 also can be provided to respond to the amount of communication and data transfer desired. In addition, IDRs 13 can be added or removed from a switching center as the data transmission needs change provided that sufficient bandwidth is available on the transmission lines 2.

The actual rate of data transmission is typically not homogeneous across all networks. For example, the data transmission rate may be 10 Gbps on a national backbone network and 100 Mbps on a local network. In networks utilizing the IDRs 13 and switching centers 27 of the present invention, streams of data and datagrams are not statistically multiplexed or chopped into packets, but transmitted at the highest possible available rate. Moreover, the same IDR 13 can have different rates of transmission in different ports, and collect streams of data at a first speed and transmit the same stream of data a second different speed, either a higher or a lower speed as the transmission line allows.

The switching center 27 also includes a plurality of concentrators 28 coupled to a plurality of outputs 29 from a plurality of IDRs 13 to combine a plurality of slower rate outputs 29 into a single high-speed stream of data 30. These outputs 29 can represent a single input or multiple inputs on the concentrator. Preferably, each concentrator 28 includes a sufficient amount of memory to receive multiple streams of datagrams at slow rate, to store each datagram in memory, and then retransmit the datagrams one at a time at a faster rate. The datagrams will not be broken into packets with the packets statistically multiplexed, but each datagram will remain intact and be sent whole at a faster rate and shorter time. In one example, the slow data transmission rate is 2.5 Gbps and the fast rate is 10 Gbps. In this example, four slower outputs are combined into one faster output. The output 30 is a tributary output, and many such outputs 30 may be WDM multiplexed into transmission line 2 (not shown). Under-utilization of the capacity in the transmission lines and in the memory of the concentrator minimizes data blocking and transmission delays. Unlike statistical multiplexing, the present invention provides the benefit of eliminating the need to chop and groom the incoming data. Unlike multiplexors, the concentrators combine without deconstructing the data stream.

The switching center also includes a plurality of de-concentrators 31 coupled to a plurality of IDR inputs. The de-concentrator breaks down a single input stream of data 32 containing fast going datagrams arriving at the splitter from a tributary transmission line 32. The tributary transmission line 32 accepts data from a WDM demutliplexer that is connected to an incoming transmission line 2. The input stream of datagrams is broken down into a plurality of input streams of datagrams 33 that are connected to the inputs of the LDDRs. Preferably, the transmission lines, IDRs, concentrators, and splitters of the present invention have optical interconnect with common fiber optics, although devices with electronic interconnects using coaxial or twisted pairs wires may also be used.

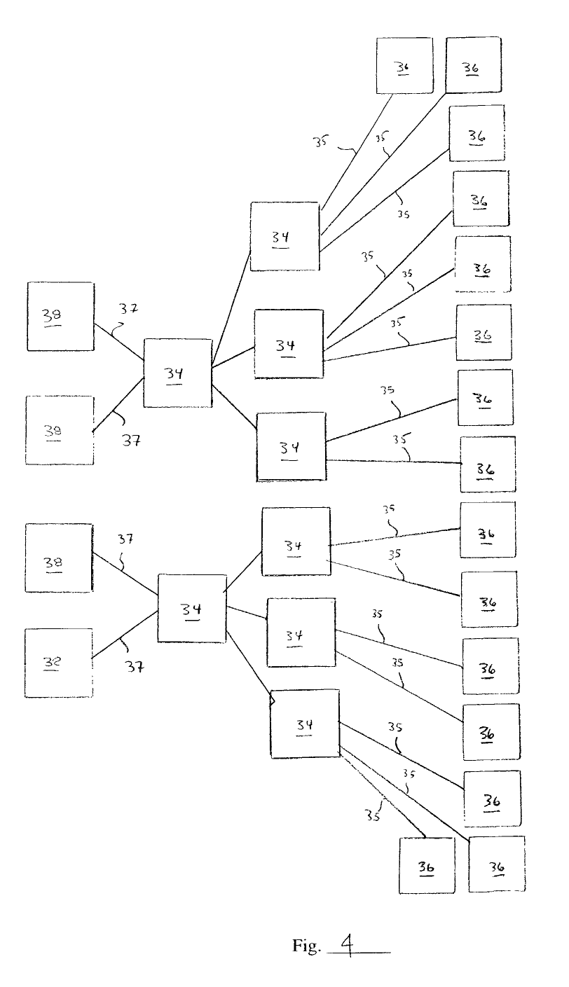

With regard to the interface between the national backbone network and a local network, of the potentially many IDRs in the switching center 27, certain number can have a communication line or connection 40 to a local network. The local network is arranged like the national backbone network; however, the local network can have fewer IDRs. As shown in FIG. 4, to compensate for this difference in the number of IDRs 13 in the national backbone network and the number of IDRs in the local network, one or more layers of interface IDRs 34 can be provided. Backbone outputs 35 from a plurality of backbone IDRs 36 are connected and combined through a series or sequence of interface IDRs 34 to create the proper number of local inputs 37 for the local network IDRs 38. The interface routers 34 have assigned ports to connect to the backbone IDRs 36, and the total number of ports preferably equals total number of backbone outputs. Local networks and other networks can be constructed in the same fashion as described herein. Such networks can have IDRs functioning at various port speeds, have different numbers and configurations of: IDRs, multiplexors, demultiplexors, concentrators, and deconcentrators. The interface between different level networks can include IDRs, concentrators, and deconcentrators in various arrangements to accommodate various transmission rates.

With regard to interface between two separate national backbones, certain number (or, in some embodiments, all) of the IDRs in a switching center may have ports connected to communications lines 33 that lead to other backbone networks.

In use, incoming streams of data on communications lines 2 arrive at a switching center. Each cable is split to the individual fibers, and then each fiber is entering WDM equipment and exiting as individual wavelengths on individual tributary fibers. The tributary fibers can directly enter IDRs 13 or pass via concentrators or de-concentrators to match the data rate to the IDRs 13. The IDRs 13 of the present invention receive an input datagram, and the processor determines the direction in which this stream of data should be headed relative to the IDR 13. The direction may be any transmission line 2, a connection 40 to a local network, or connection 41 to another backbone. The IDR then directs the stream of data to the appropriate output. In IP for example, each datagram includes a first part containing the destination information for the stream of data and a second part containing the actual message or data. In at least one embodiment, the first part of the stream of data containing the destination information is included in a header having several layers of abstraction. The abstraction will carry information of which national network and on which sub-network or local network the destination reside, since intermediate IDRs only need information about the general direction in which to send the stream of data. This level of abstraction increases the speed at which data streams can be routed.

For a stream of data destined for another backbone network, the locations of contact between the national backbone networks are stored in a database or table to which the IDR 13 has developed by calling all other IDRs that it has connection to. Of these, some are in other switching centers 27 and some are in the same switching centers 27. The locations of the points of contact that require the lowest hops via other IDRs 13 are noted, and the datagram is routed to the nearest location where the two backbones connect. If the switching center in which the IDR 13 is located has a connection to the other national backbone network, the stream of data is directed to the appropriate port 41.

The outgoing stream of data is routed by the IDR to the port 16 that connects to the correct transmission line 2. The outgoing tributary fiber is possibly passing through a concentrator or de-concentrator, and passing via the WDM to be transmitted by transmission line 2. There is no regard to the specific fiber, the specific transmission frequency or wavelength, and there is no time slot since the datagram is sent as a monolithic unit. For example, an incoming stream of data that is destined for a location served by the network North of the IDR location is sent to the north-going input/output pair. The stream of data is sent on the transmission wavelength or frequency associated with that pair and the transmission line connected to that pair. The exact wavelength associated with the pair is not important as long as the direction is correct. The datagram will be sent as-is, at the transmission rate, without statistical multiplexing, but with WDM only.

In another example, a stream of data destined for a local network will be routed to the input/output pair that is attached to the connection 40 that leads to the local network.

When there is a need to route a datagram to a specific port, say 17, which is currently in use transmitting another datagram, the blocked datagram can be stored in the IDR memory to be sent to port 17 when it is available. However, if port 17 is serving a very long datagram or is malfunctioning due to some problem in the transmission line, the blocked datagram can be routed to another IDR in the same switching center via one of interconnections 39 and continue from there to the right direction.

Since each stream of data on a particular wavelength does not have be deconstructed, does not have to be assigned a specific time slot in a specific wavelength in a specific fiber, but is merely routed in the general direction of its destination information, more efficient and expedient data routing is achieved by making the datagrams as long as possible. In some embodiments, each datagram is sent full length, with only one header. In addition, there is no need to communicate with the IDR on the receiving end of the transmission line on which time slot and on which wavelength to look for a datagram. This reduces substantially the need for router inter-communications and eliminates the need for precise timing of the time slots. Shorter or longer datagrams are possible; however, longer datagrams are more efficient to transmit because destination determination and routing are done once for each datagram as opposed to multiple times as is the case in a multiplexed stream of data having multiple packets for each datagram.

In order to properly and efficiently route incoming streams of data, each IDR needs to have knowledge of the network and switching center in which it is located and the availability of the transmission lines and IDRs therein. In one embodiment, in order to obtain and maintain the necessary knowledge, after an IDR is powered up, all of the input/output pairs are checked and the interconnected IDRs, transmission lines, and other routers are identified. The interconnected structures are segregated by locations such as same switching centers 27 or remote switching centers 27, and directional information is attached. In addition, a table of interconnected local servers and a listing of other backbone networks connections is obtained. All of this information collection continues on an on-going basis and is therefore updated as the network changes. Suitable opportunities to update this information include during idle periods when no transmissions are passing through a particular input/output pair and during receipt confirmation of transmitted data as verification that the connection is active. The destination information for a data stream is compared against the network structure and the updated transmission route information.

In addition to each IDR 13 independently obtaining and maintaining information about its network structure and availability, the IDRs 13 in a switching center 27 preferably share information about available transmission directions. For example, if the transmission line 2 between Dallas 7 and Denver 6 is severed and data transmission is halted. IDRs 13 within the Dallas switching center 7 share information about available transmission directions to avoid the situation where a datagram destined North from Dallas is being transferred over and over again among the IDRs 13 in Dallas looking for an available port to Denver. If all wavelengths to Denver are congested or totally severed, then North-going datagrams will be routed East or West instead, that is in the general direction of Denver. Alternatively, a stream of data intended for one data route through a first IDR 13 can be routed to a second switching center or through a second IDR 13 along an alternative route if the first route is unavailable. The IDR 13 compares the destination information with the network structure and the location of other switching centers and sends the data stream directly to the destination switching center 27 or to any other switching center 27 in the direction of the destination, if such direct line is not available. This intercommunication facilitates self-regulation of the network for both congestions and equipment malfunctions.

Preferably, when one data route out of a first IDR 13 is unavailable, the stream of data is sent, in a rather arbitrary fashion, through a second IDR 13 to take the first available alternative route in the desired direction. Each switching center 27 can include hundreds of IDRs 13, and an equivalency should be established among all of these IDRs 13 so that one IDR 13 will not repeatedly try to seek the same specific alternative IDR 13 in the switching center 27. Again, the transmission lines are preferably loaded to less than full capacity. In one embodiment, the transmission lines are loaded to about half capacity, providing for about a 50% probability that an outgoing stream of data will be routed to the proper destination the first time it enters an IDR 13.

Varying of the quality of service (QoS) across a network can be accommodated by the present invention. For example, requests for a dedicated transmission line (akin to circuit switching) can be contained in the destination information header of a stream of data. For diversity routing, a user may set up two different private lines, and request different routing. In one application, each switching center in a hub may be divided into two or more centers in different physical locations, and direct connections to two centers are established. In another embodiment, the destination information can include a broadcast request to allow delivery of a stream of data simultaneously to multiple locations, e.g., for distribution of movies, for backup of data, or for mirroring sites.

In one embodiment, a continuous transmission from a source to a destination can be included in the destination information. In another embodiment, a corresponding reverse transmission line can be reserved for confirmation and reverse data. These options provide an increased QoS, and can result in increased costs. In addition to requests sent with the original destination information associated with a stream of data, repeat requests for these increased QoSs may need to be resent periodically to keep them active.

It should be noted that special circumstances, such as QoS requirements, might dictated either a dedicated channel (akin to circuit switching) or some packetization of data, this disclosure describes what is the nominal switching mechanism in networks of the type disclosed herein.

While the present invention has been described and illustrated herein with respect to the preferred embodiments, it should be apparent that various modifications, adaptations, and variations may be made utilizing the teachings of the present disclosure without departing from the scope of the invention and are intended to be within the scope of the present invention.

What is claimed is:

1. A router for routing a datagram:
at least one input operative to accept a single stream of data;
a plurality of outputs, each output operative to transmit a single stream of data; and
a processor:
in communication with:
at least one at least one input, and
a plurality of the plurality of outputs operative to:
read destination information from a datagram provided via a communicated input, and
determine which communicated output will advance the read datagram toward the destination indicted in the datagram, and
direct the read datagram to a communicated output determined to advance the read datagram toward the read datagram's destination;
without deconstructing the data portion of the datagram.

2. The router as in claim 1, further comprising
at least one interconnection operative for communication with another router.

3. A switching center, comprising
at least one demultiplexor, each demultiplexor operative to receive an aggregate stream of data and extract at least one individual stream therefrom,
at least one intact datagram router, each intact datagram router comprising:
at least one input operative to accept a single stream of data;
a plurality of outputs, each output operative to transmit a single stream of data; and
a processor:
in communication with:
at least one at least one input, and
a plurality of the plurality of outputs
operative to:
read destination information from a datagram provided via a communicated input, and
determine which communicated output will advance the read datagram toward the destination indicted in the datagram, and
direct the read datagram to a communicated output determined to advance the read datagram toward the read datagram's destination;
without deconstructing the data portion of the datagram.
at least one mulitplexor, each multiplexor,
in communication with at least one intact datagram router
operative to receive a plurality of individual streams of data and combine the received data streams into at least one aggregate stream of data.

4. The switching center as in claim 3,
wherein at least one demultiplexor is a wavelength division demultiplexor.

5. The switching center as in claim 3,
wherein at least one multiplexor is a wavelength division multiplexor.

6. A switching center comprising:
at least one deconcentrator
at least one intact datagram router, each intact datagram router comprising:
at least one input operative to accept a single stream of data;
a plurality of outputs, each output operative to transmit a single stream of data; and
at least one processor, each processor:
in communication with:
at least one at least one input, and
a plurality of the plurality of outputs
operative to:
read destination information from a datagram provided via a communicated input, and
determine which communicated output will advance the read datagram toward the destination indicted in the datagram, and
direct the read datagram to a communicated output determined to advance the read datagram toward the read datagram's destination;
without deconstructing the data portion of the datagram.
a least one concentrator

7. A switching center comprising:
at least one from a first group consisting of: wavelength division demultiplexor and deconcentrator;
at least one intact datagram router, each intact datagram router:
at least one input operative to accept a single stream of data;
a plurality of outputs, each output operative to transmit a single stream of data; and
a processor:
in communication with:
at least one at least one input, and
a plurality of the plurality of outputs
operative to:
read destination information from a datagram provided via a communicated input, and
determine which communicated output will advance the read datagram toward the destination indicted in the datagram, and
direct the read datagram to a communicated output determined to advance the read datagram toward the read datagram's destination;
without deconstructing the data portion of the datagram.
at least from a second group consisting of: wavelength division mulitplexor and concentrator, the at least one from the second group beign compatible with the at least one from the first group.

8. A data network comprising:
at least one source swtiching center;
at least one destination switching center; and
at least one tranmission line connecting the switching centers, each tramission line comprising:
at least one fiber, each fiber characterized by a plurality of wavelengths, each wavelength characterized by the capacity to carry one data stream;
wherein each source switching center is operative to send an intact datagram to at least one destination switching center as a data stream:
without regard to the particular wavelength, and
without informing the destination switching center of the wavelength utilized.

9. A method for routing a datagram, the datagram transmitted and tranmissible intact via an individual data stream data within an aggregate data stream, the method comprising:
dividing the aggregate stream of data into at least one individual stream of data;
reading the destination information of the datagram;
routing the datagram intact along the first available individual data stream in the direction of the destination without regard to other characteristics of data stream; and
combining the individual data stream into an aggrgate data stream;
wherein each step is accomplished without deconstructing the data portion of the datagram.
